(19) United States
(12) Patent Application Publication
(10) Pub. No.: US 2010/0101377 A1
(43) Pub. Date: Apr. 29, 2010

(54) HAND TOOL

(76) Inventor: Jin-Tsai Lai, Taichung City (TW)

Correspondence Address: Chien-Hui Su, P. O. Box 70-121 Taichung, Taichung City, 40899, TW

(21) Appl. No.: 12/260,085

(22) Filed: Oct. 28, 2008

(51) Int. Cl. B25B 13/00

(52) U.S. Cl. 81/64

(57) ABSTRACT

A hand tool includes a flexible rod, a connecting member, a clutching member, a driving member, a slide sleeve, and a spring. The connecting member is connected to one end of the flexible rod. The connecting member has an annular groove and a retaining hole. The clutching member has a ring portion and two hooks extending from the ring portion. The ring portion engages with the annular groove. The driving member is received in the retaining hole. The slide sleeve is sleeved on the connecting member and the clutching member. The spring is disposed between the flexible rod and the slide sleeve to urge the slide sleeve toward a direction away from the flexible rod.

### BACKGROUND OF THE INVENTION

1. Field of the Invention

The present invention relates to a hand tool, and more particularly to a hand tool for clutching and turning the screw.

2. Description of Related Art

A conventional hand tool for turning the screw on a hose clamp in accordance with the prior art comprises a shaft and an elongate slender body member. The shaft is slidably and rotatably mounted on the body member and resiliently biased toward an abutment on the body member to grasp there between the screw on the hose clamp. The shaft has a tool head end to drivingly engage the screw head and at the other end a handle for use in turning the shaft. The abutment on the body member has a recess to receive therein the free outer end of the hose clamp screw. The conventional hand tool is only used for hose clamp. The conventional hand tool is inconvenient to use in engine compartment due to the elongate slender structure. Therefore the usage of the conventional hand tool is limited.

The present invention has arisen to mitigate and/or obviate the disadvantages of the conventional hand tool.

### SUMMARY OF THE INVENTION

The main objective of the present invention is to provide an improved a hand tool which permits user to clutch and turn the screw.

To achieve the objective, the hand tool comprises a rod body and an operational head connected to the rod body. The rod body comprises a flexible rod and a connecting member connected to one end of the flexible rod. The connecting member has an annular groove defined in an outer peripheral thereof and a retaining hole defined in one end thereof. The operational head comprises a clutching member, a driving member and a slide sleeve. The clutching member has a ring portion formed in one end thereof and two hooks extending from the ring portion. The ring portion engages with the annular groove. The driving member is received in the retaining hole for driving a screw. The slide sleeve has a receiving space defined therein and extending therethrough for receiving the connecting member and the clutching member. The slide sleeve has an annular protrusion extending from an inner peripheral thereof. A spring is sleeved on one end of the connecting member opposite to the retaining hole. The spring has one end abutting against the flexible rod and the other end abutting against the annular protrusion to urge the slide sleeve toward a direction away from the flexible rod.

When pulling the slide sleeve, the two hooks extend from the receiving space and slightly open. The screw head is received in the retaining hole and the driving member engages the slot of the screw. After releasing the slide sleeve, the two hooks retract into the receiving space and close to clutch the screw head. When turning the flexible rod, the driving member rotates to turn the screw.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a hand tool in accordance with the present invention;

FIG. 2 is an assembled perspective view of the hand tool in FIG. 1;

FIG. 3 is an operational perspective view of the hand tool in accordance with the present invention;

FIG. 4 is a cross-sectional view of the hand tool taken along line A-A in FIG. 2;

FIG. 5 is a cross-sectional view of the hand tool taken along line B-B in FIG. 3;

FIG. 6 is an operational perspective view of the hand tool, showing one end of the hand tool is engaged with a screw and the other end of the hand tool is driven by a socket spanner; and

FIG. 6-1 is a partial enlarged view in FIG. 6, showing the hook clutching the screw.

### DETAILED DESCRIPTION OF THE INVENTION

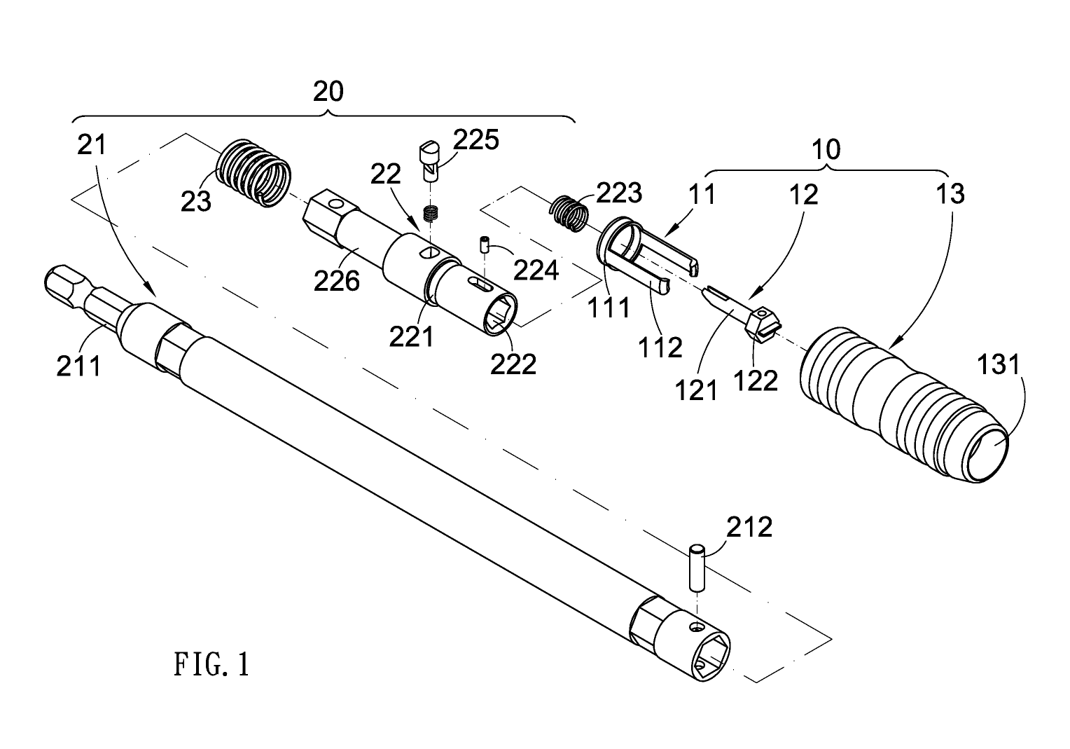

Referring to the drawings and initially to FIGS. 1-5, a hand tool in accordance with the present invention comprises a rod body 20 and an operational head 10 connected to the rod body 20.

The rod body 20 comprises a flexible rod 21 and a connecting member 22. The flexible rod 21 is made of plastic or rubber. Two ends of the flexible rod 21 are rigid and made of metal. One end of the flexible rod 21 is a hexagonal head 211 for adapting to be connected to a socket spanner. The flexible rod 21 has a receiving hole (not numbered) defined in other end thereof for receiving the connecting member 22. One end of the connecting member 22 is received in the receiving hole. A pin 212 passes through a lateral of the flexible rod 21 and one end of the connecting member 22 to secure the flexible rod 21 and the connecting member 22. The connecting member 22 has a retaining hole 222 defined in the other end thereof. The retaining hole 222 is in a shape of hexagon. The connecting member 22 has an annular groove 221 defined in an outer peripheral thereof and a neck portion 226 formed in the end thereof opposite to the retaining hole 222. A spring 23 is sleeved on the neck portion 226.

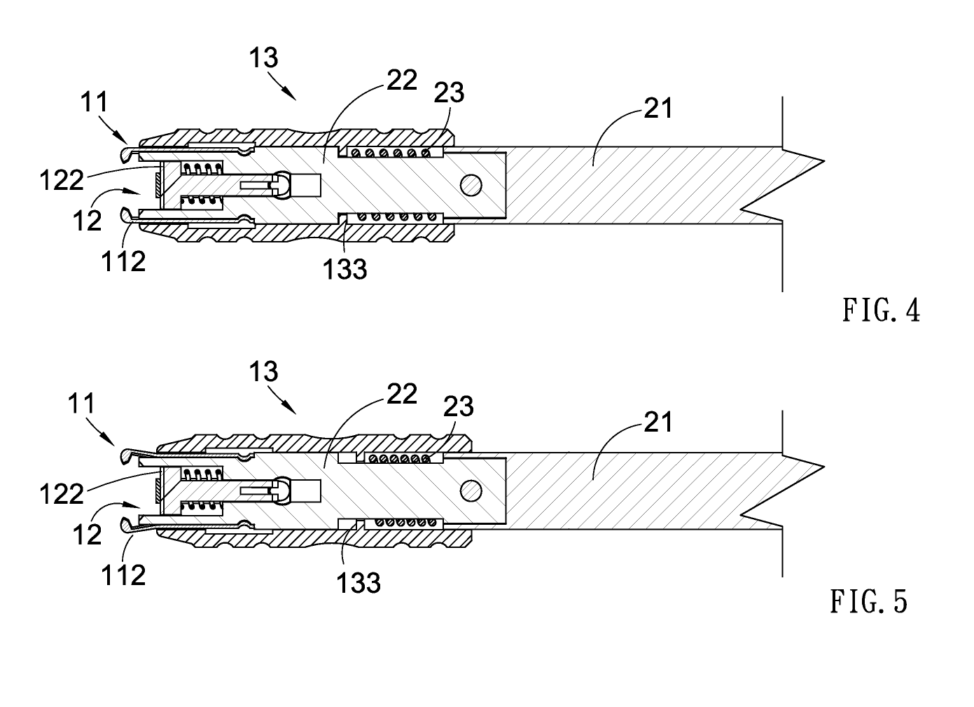

The operational head 10 comprises a clutching member 11, a driving member 12 and a slide sleeve 13. The clutching member 11 has a ring portion 111 engaged with the annular groove 221 in the connecting member 22. The clutching member 11 has two hooks 112 symmetrically extending from the ring portion 111. A length of each hook 112 is greater than a distance from the annular groove 221 to the end of the connecting member 22 same with the retaining hole 222. The driving member 12 is movably received in the retaining hole 222. The driving member 12 has a driving head 122 formed one end thereof for driving a screw. The driving head 122 is a flat blade type driver, Phillips type driver or Allen type driver. The driving head 122 has an extension rod 121 extending therefrom. A pin 224 passes through a lateral of the connecting member 22 and the driving head 122 to prevent the driving head 122 from rotating respect to the connecting member 22. A guiding pin 225 passes through the lateral of the connecting member 22 and engages with the extension rod 121. A spring 223 is sleeved on the extension rod 121. The spring 223 has one end abutting against a bottom of the retaining hole 222 and the other end abutting against the driving head 122 to urge the driving member 12 toward a direction away from the retaining hole 222. The slide sleeve 13 is tubular and defines a receiving space 131 for receiving the clutching member 11 and the connecting member 22. The two hooks 112 are slightly exposed to the slide sleeve 13. The slide sleeve 13 has an annular protrusion 133 extending from an inner peripheral thereof as shown in FIG. 4. The spring 23 has one end abutting against the flexible rod 21 and the other end abutting against the annular protrusion 133 to urge the slide sleeve 13 toward a direction away from the flexible rod 21.

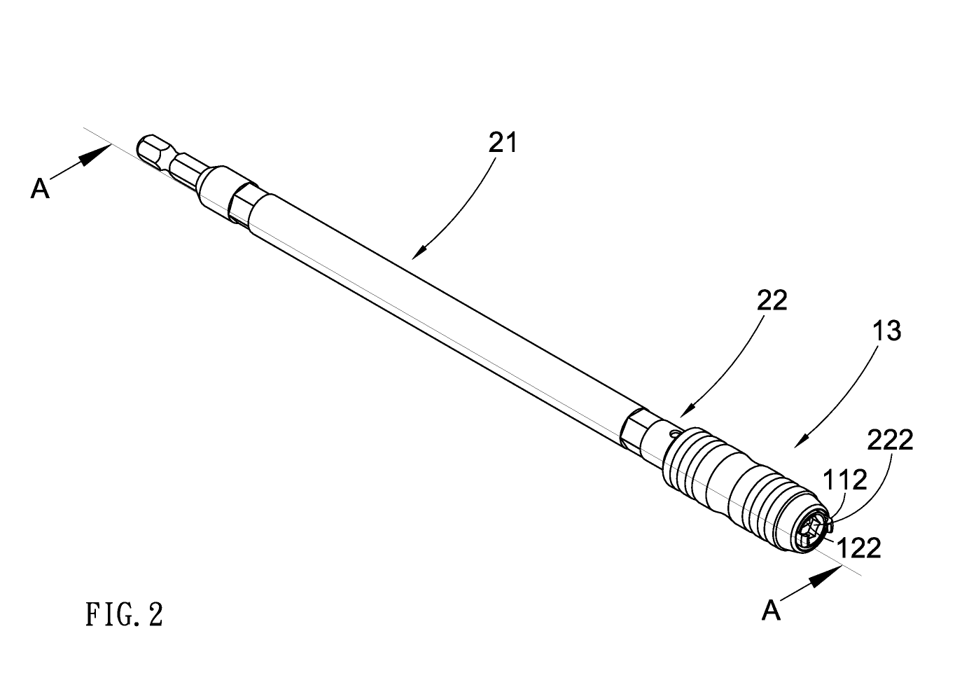

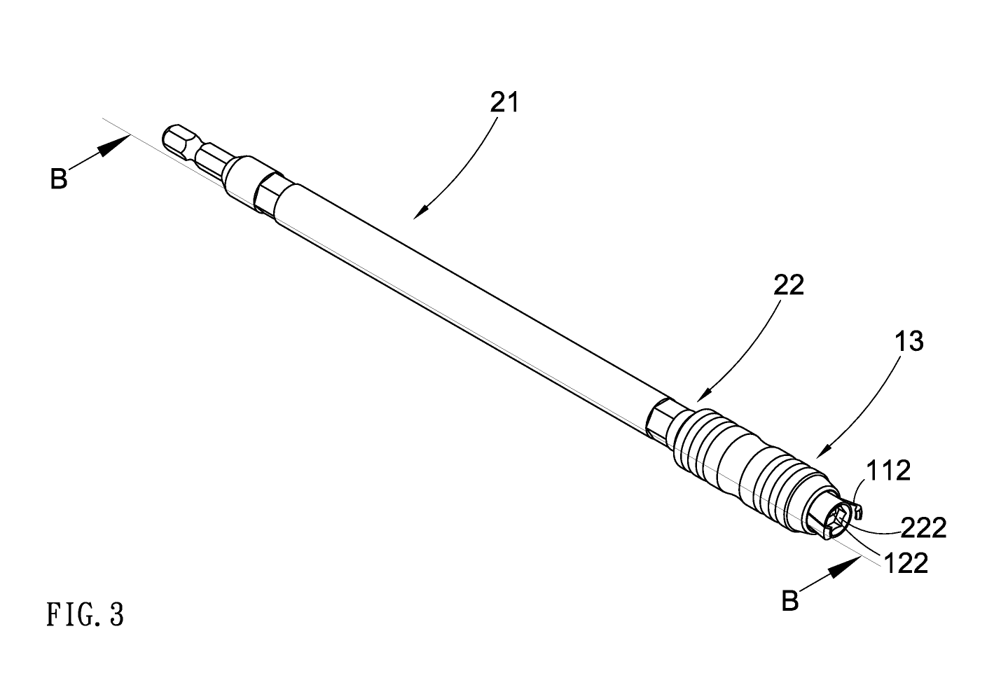

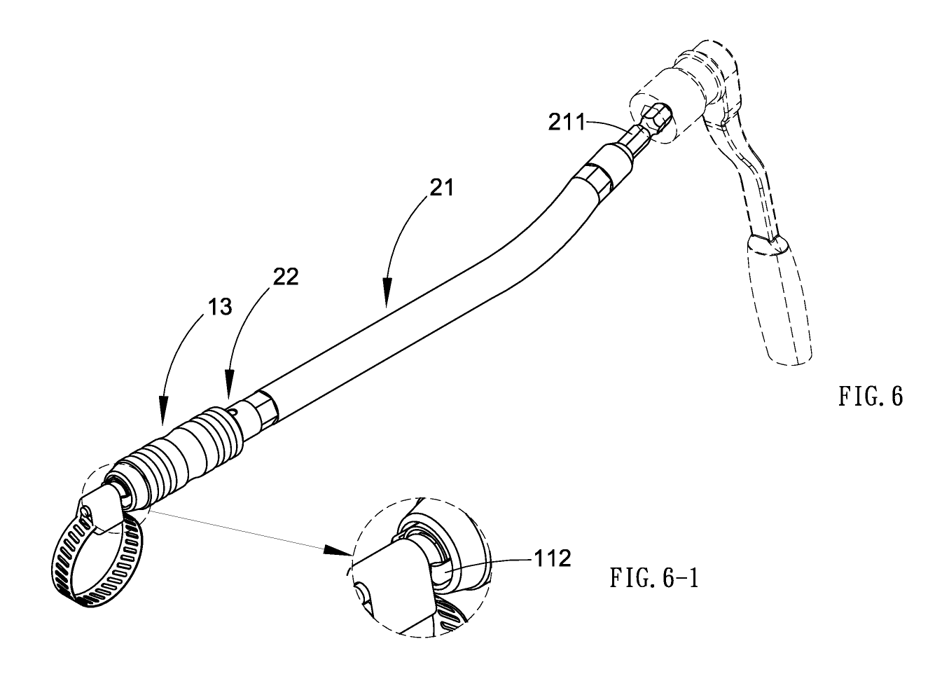

When user pulls the slide sleeve 13 toward the flexible rod 21, the spring 23 is compressed. In the meantime, the two hooks 112 extend from the receiving space 131 and slightly open as shown in FIGS. 3 and 5. When user releases the slide sleeve 13, the spring 23 pushes the slide sleeve 13 back. In the meantime, the two hooks 112 retract into the receiving space 131 and slightly close as shown in FIGS. 2 and 4. Referring to FIGS. 6 and 6-1, the operation of the hand tool in accordance with the present invention is illustrated. First, user pulls the slide sleeve 13 to open the two hooks 112. The screw head is received in the retaining hole 222. The driving head 122 engages the slot of the screw. Second, user releases the slide sleeve 13 to clutch the screw head. Third, user manually rotates the flexible rod or uses the socket spanner connecting to the hexagonal head 211 to turn the screw.

The screw head is clutched by the hooks 112 to avoid movement between the screw and the driving head 122. The flexible rod 21 is flexible to be bent for adapting any working space. Therefore the usage of the hand tool in accordance with the present invention is unlimited.

Although the invention has been explained in relation to its preferred embodiment, it is to be understood that many other possible modifications and variations can be made without departing from the spirit and scope of the invention as hereinafter claimed.

What is claimed is:

1. A hand tool comprising:
a rod body comprising a flexible rod and a connecting member connected to one end of the flexible rod, the connecting member having an annular groove defined in an outer peripheral thereof and a retaining hole defined in one end thereof,
an operational head connected to the rod body, the operational head comprising a clutching member, a driving member and a slide sleeve, the clutching member having a ring portion formed in one end thereof and two hooks extending from the ring portion, the ring portion engaged with the annular groove, the driving member received in the retaining hole for driving a screw, the slide sleeve having a receiving space defined therein and extending therethrough for receiving the connecting member and the clutching member, the slide sleeve having an annular protrusion extending from an inner peripheral thereof; and
a spring sleeved on one end of the connecting member opposite to the retaining hole, the spring having one end abutting against the flexible rod and the other end abutting against the annular protrusion to urge the slide sleeve toward a direction away from the flexible rod.

2. The hand tool as claimed in claim 1, wherein the flexible rod has a hexagonal head in one end of the flexible rod opposite to the connecting member.

3. The hand tool as claimed in claim 1, wherein the connecting member has a neck portion formed in an outer peripheral thereof for sleeving the spring.

4. The hand tool as claimed in claim 1, wherein the driving member has a driving head and an extending rod extending from the driving head, the connecting member comprising a pin passing through a lateral of the connecting member and the driving head to prevent the driving head from rotating respect to the connecting member.

5. The hand tool as claimed in claim 4, wherein the connecting member further comprises a spring having one end abutting against a bottom of the retaining hole and the other end abutting against the driving head.

6. The hand tool as claimed in claim 5, wherein the connecting member further comprises a guiding pin passing through the lateral of the connecting member and the extension rod to prevent the driving head from rotating respect to the connecting member.
